(19) United States
(12) Patent Application Publication
(10) Pub. No.: US 2025/0027779 A1
(43) Pub. Date: Jan. 23, 2025

(54) SYSTEM FOR EFFICIENTLY OPERATING MOBILITY ON-DEMAND VEHICLE LINKING TO VARIOUS TRANSPORTATIONS AND METHOD THEREOF

(71) Applicants: Mu Youl PARK, Daegu (KR); Nam Kyun KIM, Seoul (KR)

(72) Inventors: Mu Youl PARK, Daegu (KR); Nam Kyun KIM, Seoul (KR)

(21) Appl. No.: 18/731,238

(22) Filed: Jun. 1, 2024

(30) Foreign Application Priority Data
Jul. 21, 2023 (KR) 10-2023-0095325

(51) Int. Cl. G01C 21/34; G01C 21/36; G06Q 10/02; G06Q 10/047

(52) U.S. Cl. CPC G01C 21/3423; G01C 21/3469; G01C 21/3617; G06Q 10/02; G06Q 10/047

(57) ABSTRACT

The MOD system according to an embodiment of the present invention comprises a mobility service unit including a boarding request input unit for receiving, from a user, a boarding request including information on a departure point and a destination point from a user; an optimal dispatch unit for calculating an optimal dispatch and route in response to receiving the user's boarding request, and dispatching a MOD bus; and a travel calculation unit for planning a route linked with transfer means including public transportation, metropolitan transportation, or other MOD means other than the MOD vehicle in case that the departure point and the destination point belong to different areas. Accordingly, it can be provided with a MOD vehicle operation system that minimizes the inconvenience in using the MOD bus by providing seamless multiple transportation means transfer linkage even when leaving the designated area can be provided.

### CROSS-REFERENCE TO RELATED APPLICATION

This application claims the benefit of and priority to Korean Patent Application No. 10-2023-0095325 filed on Jul. 21, 2023, which are herein incorporated by reference in its entirety.

### TECHNICAL FIELD

The present invention relates to a system for operating a mobility on demand (MOD) vehicle and a method thereof. More specifically, the present invention relates to a system for operating the MOD vehicle and a method thereof which can seamlessly link the MOD vehicle to various linkage transportation means.

### BACKGROUND OF THE INVENTION

The term ‘mobility’ is defined in the dictionary as the concept of ‘the ability to move’. However, recently, in the IT-related media or startup industry, the term is used in a comprehensive sense of replacing existing traffic or transportation, even delivery and passenger transportation, including various services that provide the convenience of movement rather than the concept of the ability to move.

These mobility services have expanded to the concept of usage and sharing of vehicle rather than the traditional service area of industries related to existing automobile manufacturing and individual automobile ownership, such as manufacturing, assembly, sales, finance, insurance and repair, and have recently expanded into the concept of various sharing economies in connection with O2O (Online to Offline) technology of mobile devices. It is expanding into an economic concept. However, recent mobility services are limited to taxi services and shared personal mobility, etc., so there are limitations in complementing mass transportation such as buses and subways.

Therefore, developments of bus-based mobility services are in full swing; however, in the case of bus-based mobility services, Therefore, although the development of bus-based mobility on demand (MOD) services is in full swing, there are still many limitations to the efficiency of efficiently connecting multiple transportation means.

For example, the bus-based MOD service operates only in a certain operating area, so it is difficult to use when intending to go to a destination point outside the area. In particular, there are limitations in applying MOD buses to metropolitan areas, because there are likely to be far more demands for travelling to destination points outside the metropolitan areas. Users who prefer to travel from the departure point to the destination point at once without transfer have often selected other transportation means when leaving the service area.

From the perspective of the MOD bus operator, there is a disadvantage that cost losses may occur if demand is not considered and buses are operated with few passengers on board.

Due to the various usage/operational difficulties mentioned above, it was very difficult to commercially realize the operation of the mobility on-demand bus.

### SUMMARY OF THE INVENTION

Therefore, the present invention is to provide a MOD vehicle operation system that can minimize the user's inconvenience in using the MOD bus to thereby provide a user with a seamless multiple transportation means transfer linkage experience even when leaving the designated area. In particular, the present invention is to provide a MOD vehicle operation system that can minimize the inconvenience caused by transfer to the user by optimizing the arrival time/location of the vehicle before and after the transfer and selecting the most appropriate transfer means when linking MOD vehicle transfer. Also, the present invention is to provide a MOD system that can guarantee punctuality while being linked to public transportation means.

Also, the present invention is to provide a MOD system including a user interface that can determine the linked public transportation means to thereby allow the user to conveniently decide on a linked transportation means.

Also, the present invention is to provide a reservation means for the MOD system that can directly reflect the demand for MOD vehicles by allowing users with similar departure/destination points to board one bus if possible, and that enables the operation of MOD vehicles with maximized cost efficiency from the operator's perspective.

Also, the present invention is to provide a means capable of operating a MOD vehicle in an environment-friendly manner by providing a transfer means for the MOD vehicle according to the amount of carbon emission reduction.

However, the various problems to be solved by the present invention are not limited thereto and are included in the specific content described in the detailed description of the present invention.

### Means for Solving the Problem

In order to solve the above-described problem, a mobility on demand (MOD) system according to an embodiment of the present invention may comprise a mobility service unit including a boarding request input unit for receiving, from a user, a boarding request including information on a departure point and a destination point from a user; an optimal dispatch unit for calculating an optimal dispatch and route in response to receiving the user's boarding request, and dispatching a MOD bus; and

a travel calculation unit for planning a route linked with transfer means including public transportation, metropolitan transportation, or other MOD means other than the MOD vehicle in case that the departure point and the destination point belong to different areas.

In this case, the MOD system may further include a multiple transportation linkage unit, and the multiple transportation linkage unit may include an optimal stopover point creation unit for adding a transfer linkage stopover point for transfer to the linkage transportation means at the departure point and destination point.

Also, the MOD system may further include a multiple transportation means linkage unit, wherein the multiple transportation means linkage unit may include an optimal arrival time calculation unit based on a transfer means schedule for calculating the detour or stopover arrival time for stopover point of the MOD bus based on the arrival time and waiting time of the linked transportation means and the arrival time at the destination during detouring or stopover of the transfer linkage stopover point.

Also, the MOD system may further include a multiple transportation means linkage unit, and the multiple transportation means linkage unit may include an optimal transfer means calculation unit for recommending a linked transportation means according to the user's preferred travel condition.

Also, the user's preferred travel condition may include at least one of travel time, transfer convenience, travel convenience, in-vehicle congestion, and the amount of carbon emission reduction.

Also, the travel calculation unit may recommend a linked travel schedule based on whether to guarantee punctuality, the convenience of transferring with linked transportation means, or the amount of carbon emission reduction.

Also, the convenience of transfer with the above transfer linkage means may be determined depending on the walking distance or time.

Also, whether to guarantee the punctuality may be whether the probability calculated based on the probability density function for the user's boarding probability based on the ETA to the user's MOD vehicle alighting point, the departure time of linked transportation means that can observe the arrival time, or the walking travel time from the user's MOD vehicle alighting point to the other transportation means boarding point is greater than or equal to the reference probability.

Also, the amount of carbon emission reduction may be calculated based on the difference between the amount of carbon emission of transfer means compared to the amount of the carbon emission of passenger vehicles.

Also, the amount of carbon emission may be calculated based on the emission coefficient calculated by Equation 1 below.

$$Emission coefficient ( y ) = A ⋆ V ⋀ ( B ) ( where A and B a re constants according to transportation means , and V is speed \qquad ( Equation l )$$

Also, if the transfer means is a MOD vehicle, bus, or subway, the amount of carbon emission of the transfer means can may calculated by dividing the total amount of carbon emission based on the transit time of the transfer section by the average number of passengers in the transfer section.

Also, the mobility service unit may further include a multiple transportation means selection interface, and the travel calculation unit can recommend at least some of public transportation, metropolitan transportation, or other MOD means through the multiple transportation means selection interface.

Also, the mobility service unit may include a multiple transportation means selection interface, and the travel calculation unit can recommend at least some of public transportation, metropolitan transportation, or other MOD means as a linked travel schedule through the multiple transportation means selection interface.

Also, the travel calculation unit may recommend the linkage travel schedule in order based on at least part of whether to guarantee punctuality, the convenience of transfer or the amount of carbon emission reduction.

Also, the convenience of transfer may include walking travel distance or time, wheelchair accessibility or walkability.

### Effects of the Invention

Therefore, according to the present invention, a MOD vehicle operation system that minimizes the user's inconvenience in using the MOD bus by providing seamless multiple transportation means transfer linkage when leaving a designated area can be provided. In particular, when MOD vehicle transfer linking, a MOD vehicle operation system that can minimize the inconvenience caused by transfer to users can be provided through optimization of the arrival time/place of the vehicle before and after the transfer and selection of the most appropriate transfer means. Also, according to the present invention, a MOD system that can guarantee punctuality while being linked to public transportation, etc. can be provided.

Also, according to the present invention, a MOD system may be provided that provides a user interface capable of determining linked public transportation means so that the user can conveniently determine a linkage means.

Also, according to the present invention, a reservation means for the MOD system can be provided that can directly reflect the demand for MOD vehicles by allowing users with similar departure/destination points to board one bus if possible, and that enables the operation of MOD vehicles with maximized cost efficiency from the operator's perspective.

Also, the present invention is to provide a means capable of operating a MOD vehicle in an environment-friendly manner by providing a transfer means for the MOD vehicle according to the amount of carbon emission reduction.

Therefore, the present invention is to provide a MOD vehicle operation system that can minimize the user's inconvenience in using the MOD bus to thereby provide a user with a seamless multiple transportation means transfer linkage experience even when leaving the designated area. In particular, the present invention is to provide a MOD vehicle operation system that can minimize the inconvenience caused by transfer to the user by optimizing the arrival time/location of the vehicle before and after the transfer and selecting the most appropriate transfer means when linking MOD vehicle transfer. Also, the present invention is to provide a MOD system that can guarantee punctuality while being linked to public transportation means.

Also, the present invention is to provide a MOD system including a user interface that can determine the linked public transportation means to thereby allow the user to conveniently decide on a linked transportation means.

Also, the present invention is to provide a reservation means for the MOD system that can directly reflect the demand for MOD vehicles by allowing users with similar departure/destination points to board one bus if possible, and that enables the operation of MOD vehicles with maximized cost efficiency from the operator's perspective.

Also, the present invention is to provide a means capable of operating a MOD vehicle in an environment-friendly manner by providing a transfer means for the MOD vehicle according to the amount of carbon emission reduction.

However, the problems to be solved by the present invention are not limited to those mentioned above and variously described in the detailed description of the present invention.

The effects according to the present invention are not limited to those mentioned above and further various effects are described in the specification.

### BRIEF DESCRIPTION OF THE DRAWINGS

FIGS. 1a and 1b are schematic diagrams of MOD vehicle operation according to an embodiment of the present invention.

FIG. 2 is a block diagram of a MOD system according to an embodiment of the present invention.

FIG. 3 is a detailed block diagram of the optimal boarding and alighting point calculation unit according to an embodiment of the present invention.

FIG. 4 is a detailed block diagram of a multiple transportation means linkage unit according to an embodiment of the present invention.

FIG. 5 is a flowchart of a MOD vehicle operation method according to an embodiment of the present invention.

FIG. 6 is a flowchart of a departure/destination input/selection method according to an embodiment of the present invention.

FIG. 7 is a flowchart of a multiple transportation means linkage step according to an embodiment of the present invention.

FIGS. 8a and 8b show a flowchart of a method of selecting a boarding and alighting points and making a reservation according to an embodiment of the present invention.

FIG. 9 is a flowchart of a dispatch method according to an embodiment of the present invention.

FIGS. 10 to 12 are flowcharts of a vehicle movement and vehicle information transmission method according to an embodiment of the present invention.

FIG. 13 is a diagram showing the optimal boarding and alighting points according to an embodiment of the present invention.

FIG. 14 is a diagram showing the interface of a user terminal according to an embodiment of the present invention.

### DETAILED DESCRIPTION OF THE INVENTION

Hereinafter, embodiments of the present invention will be described in detail with reference to the attached drawings. However, the present invention is not limited to the embodiments disclosed below, but can be implemented in various different forms. The following embodiments make the disclosure of the present invention complete and are provided to fully inform those of ordinary skill in the art of the scope of the invention. Also, for convenience of explanation, the sizes of components may be exaggerated or reduced in the drawings.

However, embodiments described below are provided to enable those skilled in the art to fully understand the present invention, and may be modified into various other forms, and the scope of the present invention is not limited to the following embodiments.

Meanwhile, throughout the specification, when a certain part is said to “comprise” a certain component, this means that other component may be further included rather than excluding other component unless specifically stated to the contrary.

The above-mentioned purpose, features and advantages will become clearer through the following detailed description in relation to the attached drawings, and accordingly, a person skilled in the art to which the invention pertains will be able to easily implement the technical idea of the invention.

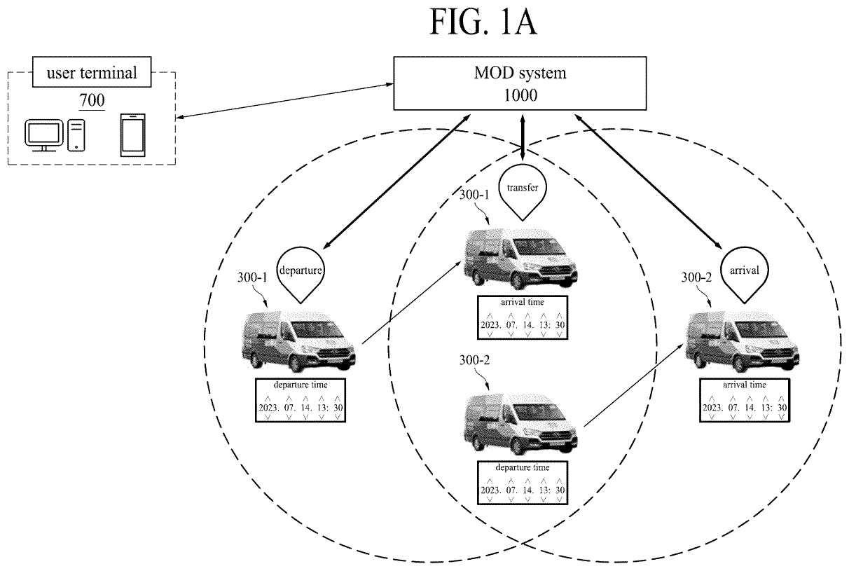

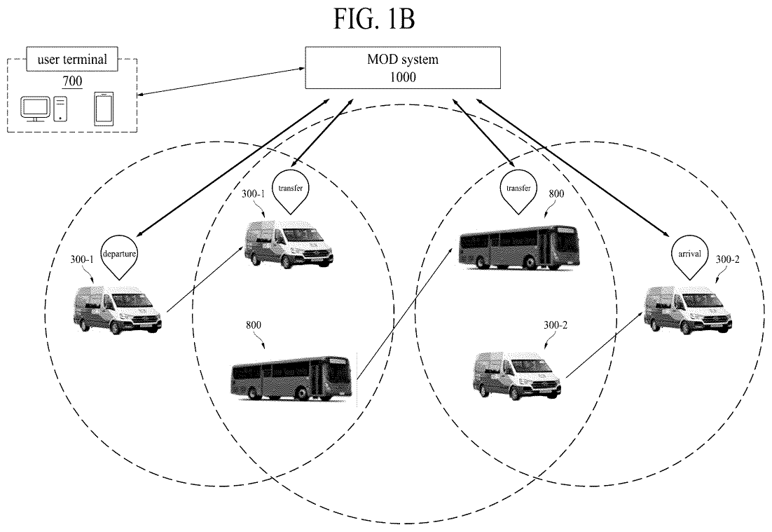

Hereinafter, the service provided by the MOD system according to an embodiment of the present invention will be described with reference to FIGS. 1a and 1b.

Referring to FIG. 1a, a MOD system 1000 according to an embodiment of the present invention is connected to a user terminal 700 and MOD vehicles 300-1 and 300-2, and may receive a boarding request including the departure and destination information from the user terminal. In this case, the MOD system 1000 calculates the optimal dispatch and route of multiple transportation methods including at least one MOD vehicles 300-1, 300-2 according to the user's boarding request and dispatches the MOD vehicle. can do. Here, the optimal dispatch and route are the guaranteed arrival time MOD vehicle dispatch and route that can arrive at the destination at the arrival time inputted by the user, or the dispatch and route inputted by the user. Guaranteed departure time can include MOD vehicle dispatch and route to arrive at the boarding point on time.

Meanwhile, referring to FIG. 1b, if the area including the departure area (departure area) and the area containing the destination (arrival area) do not overlap, the user's alighting location in the departure area is set as the departure point and the user's alighting point in the departure area is set as the departure area. Linkage transportation that uses the boarding point as the destination The MOD system 100 can provide guidance so that the user 700 can move through the linkage transportation means 800

In this case, the linkage transportation means 800 may include another MOD vehicle, public transportation, metropolitan transportation, PM, or UAM.

Through this MOD system 1000, a MOD vehicle operation system can be provided that minimizes the user's inconvenience in using the MOD bus can be provided by providing a multiple transportation means transfer linkage which is seamless even when leaving the designated area. In particular, a MOD vehicle operation system can be provided that can minimize the inconvenience caused by the transfer to users can be provided by optimizing the arrival time/location of the vehicle before and after the transfer and selecting the most appropriate transfer means during MOD vehicle transfer linkage. Also, according to the present invention, a MOD system can be provided that can guarantee punctuality while being linkage to public transportation means, etc.

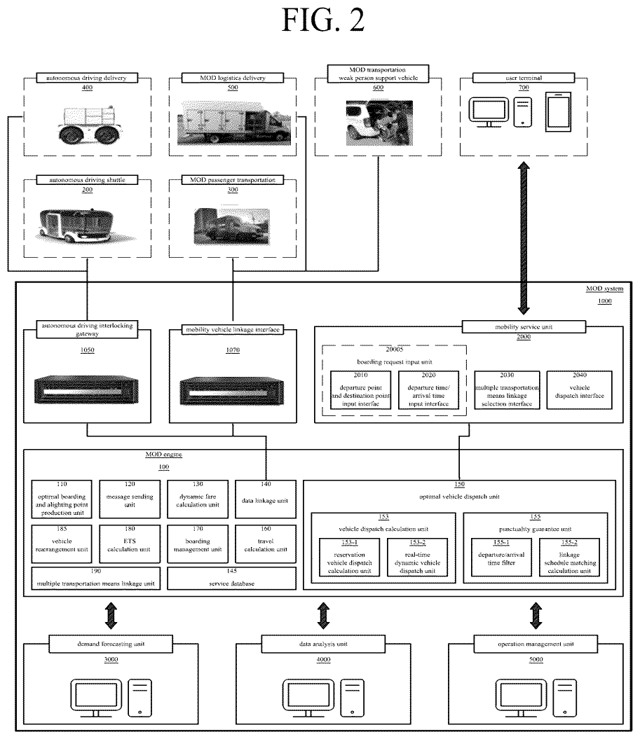

Hereinafter, with reference to FIG. 2, a MOD system according to an embodiment of the present invention will be described. FIG. 2 is a block diagram showing a MOD system according to an embodiment of the present invention.

The MOD system 1000 according to an embodiment of the present invention includes a MOD engine 100, a mobility service unit 2000, a demand forecasting unit 3000, a data analysis unit 4000, an operation management unit 5000, It may include an autonomous driving interlocking gateway (1050) and a mobility vehicle interconnection interface (1070). In this case, the vehicle linkage interface 1070 transmits and receives information about real-time location sharing, situation sharing, etc. with the MOD vehicle (200, 300, or 600) or the user terminal 700 through, for example, a RESTful API, or performs each function (e.g., optimal dispatch unit, travel calculation unit, etc.) can provide a message transmission interface between the two.

In this specification, each component of the MOD system described above may be software running on a processor, hardware, a software module running on a processor, a hardware module, or a combination of software and hardware. In particular, each component. They may each be implemented as individual servers or server groups, or may be software modules all implemented within one server. Those skilled in the art can implement and combine each component of the MOD system described above in various ways.

In this case, the MOD engine 100 performs the main functions of the MOD system, including an optimal boarding and alighting point calculation unit 110, a message sending unit 120, a dynamic fee calculation unit 130, a data linking unit 140, an optimal dispatch unit 150, an travel calculation unit 160, a boarding management unit 170, an estimated time of arrival) (ETA) calculation unit 180, a vehicle rearrangement unit 185, a multiple transportation means linkage unit 190 and a service database 145.

The optimal boarding and alighting point calculation unit 110 may estimate the user's walking route and calculates the optical point among the boarding point to pick up the user and alighting point whether the user gets off based on the possibility of dispatch, the user's walking distance, whether there is a disability, whether it is a safe point for boarding and alighting, etc.

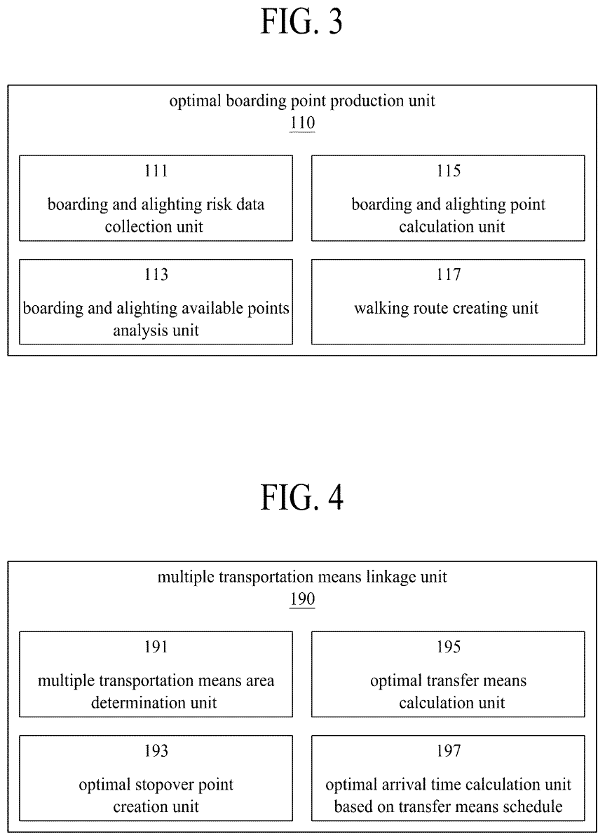

More specifically, referring to FIG. 3, the optimal boarding point calculation unit 110 may include a boarding and alighting risk data collection unit 111, an allowed boarding and alighting point analysis unit 113, a boarding and alighting point calculation unit 115 and a walking route generating unit 117.

The boarding and alighting risk data collection unit 111 in the optimal boarding point calculation unit 110 may periodically collect and store coordinate information about a point where parking and stopping are legally allowed on the road, a construction point, and a point where boarding and alighting accidents occurred, a certain distance area at an intersection where it is not allowed to get on and off, a crosswalk, etc. from the service database 145 or an external server (not shown)

In particular, the optimal boarding point calculation unit 110 can find the designated departure point or nearby roads at the user's current location, exclude an area where parking and stopping are not allowed (intersections, crosswalk, etc.) from boarding and alighting points, select preferred boarding and alighting points and calculate the integrated optimal boarding point by looking up nearby boarding and alighting points.

Meanwhile, the boarding and alighting point analysis unit 113 may generate the group of candidates for allowed boarding and alighting points among points on the road based on a dangerous point coordinate information, actual boarding and alighting history, whether there is where walking is allowed, whether a wheelchair moving is allowed, and the direction of movement of the MOD vehicle (up or down on the road), etc. corrected by a boarding and alighting risk data collection unit 111.

The boarding and alighting point calculating unit 115 may select and provide an allowed boarding and alighting point from among the allowed boarding and alighting candidates based on the user's preferred boarding and alighting point or a point similar to the user's preferred boarding and alighting point and walking travel distance or time. The point similar to the user's preferred boarding and alighting point can be determined by surrounding transportation criteria such as a distance from the crosswalk, a distance from the user's departure point, a walking transfer distance to transfer transportation means, whether walking accessibility or not, wheelchair accessibility or not, etc. or by a combination these criteria. At this time, a predetermined number of top ranking boarding and alighting points can be selected and provided by ranking each boarding and alighting candidate points in accordance with selection criteria.

The walking route generation unit 117 may generate a walking route from the departure point to the boarding point or from the alighting point to the destination point. For example, the walking route can be expressed as coordinates of links and nodes on a walkable route. The walking distance and walking time can be calculated based on the walking route generated by the walking route generation unit 117. Herein, the walking time may be determined differently depending on the weather, temperature, humidity, the user's age, gender, or whether disability or not. This information can also be received through an external server.

The message sending unit 120 may send a dispatch information message, ETA message and service general message to the terminal in the MOD vehicle 200, 300 or 600 and the user terminal 700, respectively through the mobility vehicle linkage interface 1070 and the mobility service unit 2000.

The dynamic fare calculation unit 130 can calculate fares based on user-specific fare plan (fare table), boarding history, whether entry into a premium section or not, detour route information, travel distance reservation discount information, etc. When reservation dispatch is performed, the dynamic fare calculation unit 130 may discount the fare of the user who requested reservation dispatch.

The data interworking unit 140 may interwork with MOD engine 100 by transceiving, through a mobility vehicle interworking interface 1070, an autonomous driving interworking gateway 1050 and a mobility service unit 2000, for example, an autonomous driving shuttle 200, a MOD passenger transport vehicle 300, an autonomous driving delivery vehicle 400, MOD logistics delivery vehicle 500, a MOD transportation weakling support vehicle 600, or real-time location of user terminal 700, vehicle data such as speed, direction and passenger boarding information, etc., dispatch information, vehicle control information of the autonomous driving shuttle 200 or autonomous driving delivery vehicle 400, etc. In addition, the data interworking unit 140 may store a boarding history, MOD vehicle operation data, etc. in a service database 145.

The service database 145 can store and transmit various information required for service, such as vehicle location, MOD operation route, ETA, dispatch information, etc.

The optimal dispatch unit 150 can perform real-time dynamic dispatch or pre-scheduled dispatch of the MOD vehicle based on the boarding and alighting points in the dispatch request from the boarding request input unit 2005 of the mobility service unit 2000 and then generate real-time/pre-scheduled dispatch information. Reservation dispatch information can be created. In this case, the dispatch information may include vehicle ID, driving route, and ETA information.

In more detail, the optimal dispatch unit 150 may include a dispatch calculation unit 153 and a punctuality guarantee unit 155.

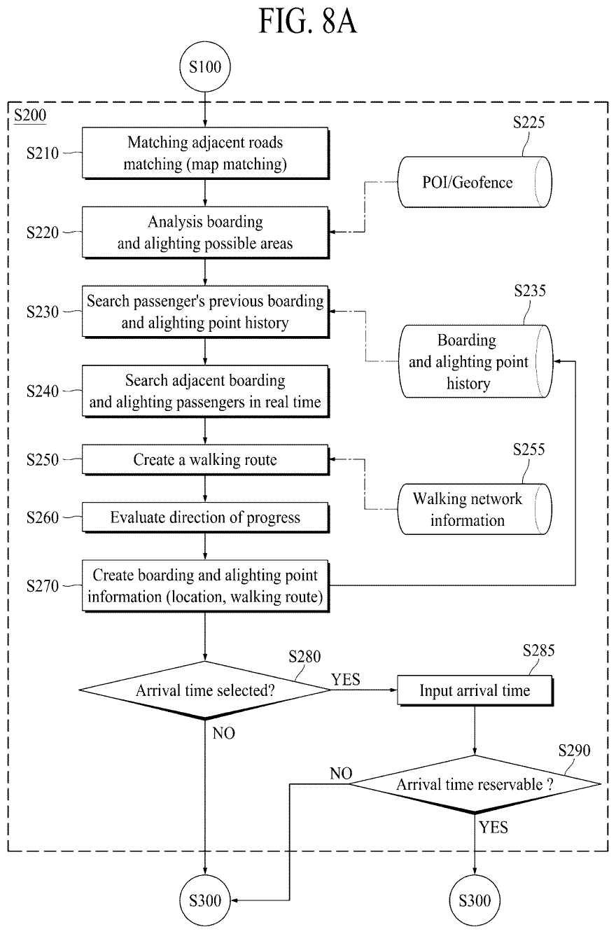

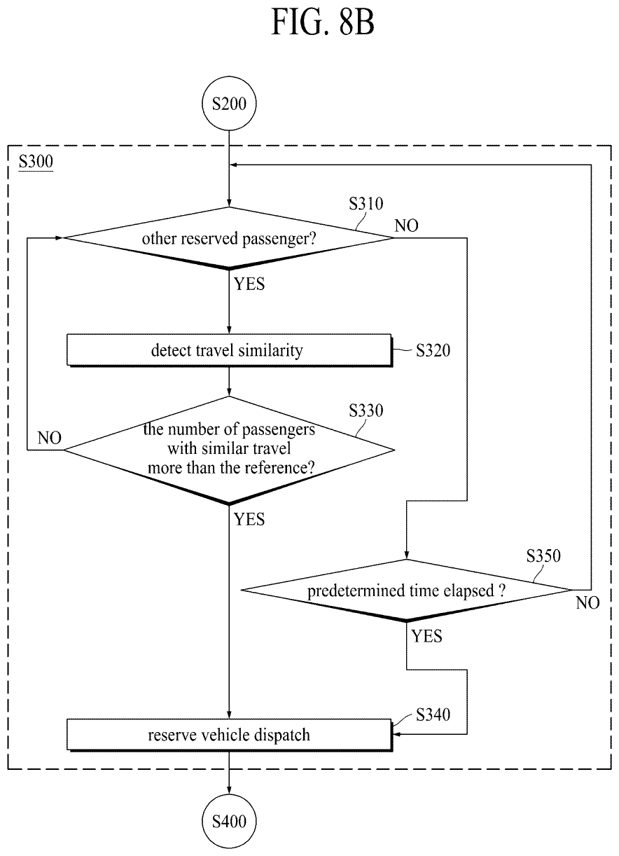

The dispatch calculation unit 153 may include a reservation dispatch calculation unit 153-1 and a real-time dynamic dispatch calculation unit 153-2, and may perform reservation/dynamic dispatch operation of the reservation dispatch calculation dispatch operations. The reservation unit 153-1 will be described in detail with reference to FIG. 8B.

The real-time dynamic dispatch calculation unit 153-2 can perform real-time/dynamic dispatch from among searched dispatch-available vehicles based on the detour time of existing boarded passengers, the possibility of observing the arrival time of dispatch requesting user and the possibility of observing the arrival time of the existing boarded passenger when boarding of the dispatch requesting user. For example, if the user's boarding point ETA increases significantly due to a specific event occurring while the user is waiting (e.g., stop at a traffic light, traffic jam, etc.), the real-time dynamic dispatch calculation unit 153-2 may dispatch other MOD vehicles in real time. can be dispatched.

This real-time dynamic dispatch calculation unit 153 can be machine-learned in terms of passenger satisfaction and service operation efficiency.

For example, in terms of passenger satisfaction, the real-time dynamic dispatch calculation unit 153 may generate a machine-learned preferred route based on minimization of travel time from boarding to alighting, minimization of waiting time from dispatch to boarding, minimization of detour time due to boarding of passengers requesting new dispatch, increase of the dispatch success rate and decrease of route congestion. Alternatively, in terms of service operation efficiency, the real-time dynamic dispatch calculation unit 153 may generate a machine-learned preferred route based on a decrease in total travel time, an increase in the number of passengers per vehicle, a decrease in a tolerance occurrence time, an increase in the number of boarding and alighting people at one boarding and alighting point, and an increase in the total number of transportation persons. The machine-learning can be learned in a variety of ways, including Bayesian probability applications, decision tree models, support vector machines, and neural network circuits.

For example, when selecting a node or link on a route, a node or link from the route, the real-time dynamic dispatch calculation unit 153 can select the route based on performance indicators for each link or node (e.g., travel time, waiting time and detour time when passing a link, actual vehicle rate for each link, total number of persons transported for each link) and configure the route by combining the selected nodes or links. Alternatively, the real-time dynamic dispatch calculation unit 153 may select performance by route You can also select the route based on route-specific indicators.

The punctuality guarantee unit 155 can perform operations for observing punctuality of arrival/departure time and include a departure/arrival time filter 155-1 and a linkage schedule matching calculation unit 155-2. In particular, in the case of commuting time, there is a fixed time to arrive at the destination (company, railroad, subway, metropolitan bus, etc.), and thus it can guarantee to dispatch a vehicle that can arrive at the relevant time.

Departure/arrival time filter 155-1 can determine whether the arrival observation is possible by ensuring that the probability to observe the arrival time, which was calculated based on the probability density function for the possibility of the user's boarding based on an ETA to alighting point, departure time of linkage transportation means 800 that can observe the arrival time and the user's walking travel time from the MOD vehicle alighting point to other transportation means boarding point, is greater than the reference probability.

For example, the probability density function can be generated based on the arrival time observation history data of bus for each time zone and on final arrival time tracking data according to boarding time. For example, after receiving consent to input the final arrival time, the arrival time within a certain range from the set destination can be confirmed through user terminal tracking, so the probability density function between the boarding time for each time zone and whether or not observation of the arrival time can be obtained.

When linkage transportation means 800 is public transportation means or metropolitan transportation means, the linkage schedule matching calculation unit 155-2 can search MOD vehicles 200, 300 or 600 based on the station-stop time of the linkage transportation means 800 and perform a linkage matching function. In other words, when the candidate group of the linkage transportation means 800 is public transportation means or metropolitan transportation means, the linkage schedule matching calculation unit 155-2 can perform the function of linking and matching reservation/standby MOD vehicles 200, 300, or 600 that can fit the schedule of the corresponding means.

Meanwhile, the linkage schedule matching calculation unit 155-2 can perform an operation for ensuring that the MOD bus is dispatched in accordance with the departure or arrival time of the linkage transportation means inputted by the user.

In addition, the linkage schedule matching calculation unit 155-2 can perform the calculation of the arrival and departure times of a linkage transportation means that departs within a certain distance from the alighting point within a certain time including the walking time from the arrival time at the alighting point of the MOD vehicle or the calculation of the arrival and departure times of a linkage transportation means that arrives within a certain distance from the boarding point within a certain time including walking time from the departure time at the boarding point of the MOD vehicle Calculations of the arrival and departure times of the means can be performed.

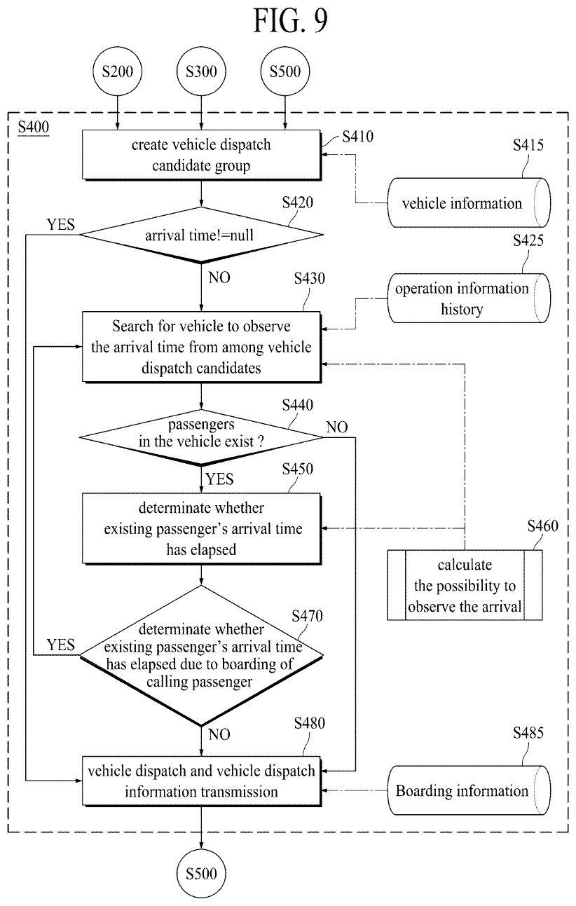

The punctuality guaranteeing operations through the punctuality guarantee unit 155 and the interlocking operations of the optimal dispatch unit 150 will be described in detail in the description with reference to FIG. 9.

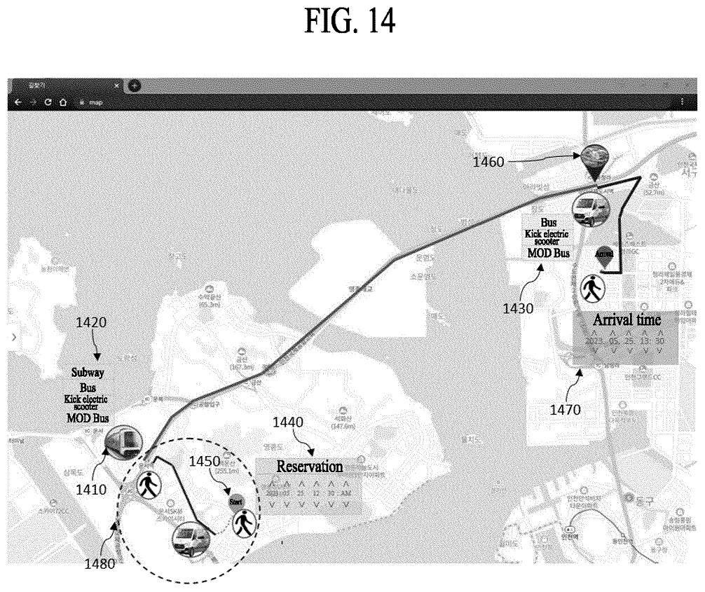

Meanwhile, the travel calculation unit 160 determines whether the departure point and destination point are within the area of the MOD system while being linkage to the multiple transportation linkage unit 190, and then recommends the linkage schedule if the departure point or destination point is outside the area. In this case, the travel calculation unit 160 can recommend the optimal linkage travel schedule based on whether or not the punctuality can be guaranteed, the convenience of transfer with the transfer linking means (walking distance or time, or whether a wheelchair is possible, walking distance, etc.) and the amount of carbon emission reduction from among the plurality of transfer linkable vehicles proposed by the multiple transportation means linkage unit 190. Likewise, walking distance or time and walking availability depend on the user's It may be calculated differently depending on age, disability, etc. In this case, the recommendation can be made, for example, by displaying it in the means selection menus 1420 and 1430 of FIG. 14. In this case, the recommendation may include whether punctuality can be guaranteed, the convenience of transfer with the transfer linkage means (walking distance, or can be recommended in order based on at least some of the following (time, wheelchair availability, walking availability, etc.) or carbon emission reduction.

The boarding management unit 170 can perform payment confirmation for dispatch request and issuance of boarding pass, and can receive and collect the boarding and alighting information from the autonomous driving shuttle 200, MOD passenger transportation vehicle 300, or MOD transportation weak person support vehicle 600. In this case, the collected boarding and alighting information can be used for demand forecasting, analysis of boarding and alighting points, analysis of movement pattern, and analysis of user preferred moving means.

The ETA calculation unit 180 can perform real-time ETA calculation based on the driving route (node and link information) between boarding and alighting points, and can perform a demand estimation ETA calculation which reflects passing through the demand estimation point. Here, the demand estimation point means an area where the probability of demand occurring is above a certain level. Alternatively, the ETA calculation unit 180 may calculate the ETA which is estimated under a specific situation. For example, if there is a new dispatch request, the ETA calculation unit 180 can compute the detour time of existing passenger when MOD vehicles which are dispatch-available at the boarding point of the user who requested the new dispatch pass through the user's boarding point.

Meanwhile, the vehicle rearrangement unit 185 can calculate the optimal rearrangement location of the empty vehicle based on boarding demand and transmit the rearrangement information to the vehicle. For example, in the case of empty vehicle without passengers on board, the vehicle rearrangement unit 185 can rearrange the vehicles at parking-available areas adjacent to the above-mentioned points based on a demand forecast point (specific times and days when demand is likely to occur), vehicle charging or refueling points, boarding point of reserved dispatch, etc. This realignment enables to shorten passenger's pick-up time, providing a better experience for passengers and also considering reducing vehicle operating costs, to thereby enjoy the effects of passenger satisfaction and saving of vehicle operating cost.

The vehicle rearrangement unit 185 can perform functions of generating and providing information for enabling the MOD vehicle 200, 300, or 600 without the user on board to move to an appropriate location based on demand, vehicle refueling, charging status, and reservation information. For example, the vehicle rearrangement unit 185 operates at multi-demand boarding and alighting points (e.g., a station with the minimum sum of distances to other high-traffic population stops among high-traffic population stops with a corresponding time-flowing population above the reference among boarding and alighting points) or reserved passengers. The MOD vehicle 200 without a user on board can be placed at a certain number of stops or more.

Meanwhile, when the departure point and the destination point are included in different areas (geofences), that is, when the corresponding travel is outside the area, the multiple transportation means linkage unit 190 can provide information on various linkable MOD vehicles 200, 300 and 600 as well as on other transportation means such as public transportation of buses, subways and the like, metropolitan transportation of trains/airplanes, personal mobility (PM), urban air mobility (UAM), etc. and personal transportation, and can determine transfer-availability for each transportation means.

Referring to FIG. 3, the multiple transportation means linkage unit 190 includes a multiple transportation means area determination unit 191, an optimal stopover point creation unit 193, an optimal transfer means calculation unit 195, and an optimal arrival time calculation unit 197 based on the transfer means schedule.

The multiple transportation means area determination unit 191 can determine whether the departure point or destination point is within the area of the MOD system (100 0). For this determination, for example, a geofence within a certain radius from the boarding and alighting available point can be defined, and the area outside the geofence can be determined as outside the area.

The optimal stopover point creation unit 193 can calculate the travel by adding a transfer linkage stopover point to the departure point and the destination point inputted by the user for transfer (linkage) with other transportation means. The transfer linkage stopover point can be added when a transfer-easy area, for example, a transfer center 1460 (see FIG. 14) or a point where the transfer frequently occurs (e.g., an area where the user or other users have transferred more than a certain number of times) is in an adjacent area of the expected route (e.g., an area that the straight line distance from the expected route is within a certain distance or the detour time to the transfer center 1460 or the point where the transfer frequently occurs is less than a predetermined time).

The optimal arrival time calculation unit 197 based on the transfer means schedule can calculate the arrival time at the transfer stopover point considering the departure or arrival time of other transportation means for a smooth transfer during transfer with other transportation means. More specifically, the optimal arrival time calculation unit 197 based on the transfer means schedule can calculate the detour or transfer arrival time for the available transfer points including the transfer center when determining the transfer linkage stopover point, and at this time, the optimal arrival time calculation unit 197 can calculate the arrival time at each transfer stopover point and the arrival time at the final destination point based on the arrival time and waiting time of linkage transportation means 800 such as bus, PM, subway, UAM, etc. In other words, based on the arrival time and waiting time of the linked transportation means, the arrival time of the MOD bus by detour or via transit at the transfer connection stopover and the arrival time of the destination when detouring or via transit connection stopover can be calculated.

Meanwhile, transfer points corresponding to a predetermined number of highest-ranked arrival times can be recommended based on the ranking by the detour or stopover arrival time for the final destination point arriving via the transfer stopover point.

Meanwhile, the optimal transfer means calculation unit 195 can suggest (recommend) a transfer (linkage) means that meets moving conditions preferred (inputted) by the user. In this case, the moving conditions may include at least one of moving time, moving convenience, travel convenience, in-vehicle congestion, and the amount of carbon emission reduction. Here, transfer convenience may mean, for example, the walking distance or time during transfer, and the moving convenience relates to whether it is easy for transportation weak person such as the disabled or the elderly to move, and may mean, for example, the ground slope angle of the walking route, the presence or absence (wheelchair accessibility) of uneven surfaces (stairs, etc.) on the route, whether or not elevators are installed for the elderly and disabled on the route, and the walking distance, etc. In-vehicle congestion may mean, for example, the actual number of passengers on board compared to the total number of passengers that can be accommodated inside the vehicle.

Meanwhile, the optimal transfer means calculation unit 195 may search for public transportation means, metropolitan transportation means, PM, or UAM (hereinafter referred to as ‘linkage transportation means’) to create a linkage travel route.

For example, in case of using linkage transportation means after alighting from the MOD vehicle, it is possible to search for public transportation means or metropolitan transportation means based on the walking distance or time from the MOD vehicle alighting point to the boarding point of the linkage transportation means, and the departure time of the linkage transportation means. In case that the final arrival time has been specified, the travel calculation unit 160 can work in conjunction with the punctuality guarantee unit 155 to present the MOD departure time in reverse by taking into account the operation time of the linkage transportation means.

Conversely, in case of using a MOD vehicle after alighting from a linkage transportation means, the MOD vehicle can be reservation-dispatched based on the expected alighting time of the linkage transportation means and the walking distance or time from the expected alighting point to the MOD vehicle boarding point. Also, in case that the final arrival time has been specified, the travel calculation unit 160 works in conjunction with the punctuality guarantee unit 155 to present the departure time of the linkage transportation means by taking into account the operation timetable of the linkage transportation means, and based on the presented departure time, the optimal transfer means calculation unit 195 can search for linkage transportation means.

At this time, in case that the linkage transportation means is PM or UAM, the optimal transfer means calculation unit 195 can check and reserve the PM or UAM means closest to the user's alighting point (alighting point of MOD vehicle or public/wide-area transportation means). The PM can check the presence or absence of adjacent PM through communication means such as Bluetooth. Here, adjacency means being within the coverage area of said communication means. In case that there are no adjacent PM or UAM means or the number thereof is less than a certain number, the reserved PM or UAM means cannot be operated by others during the reservation. However, in case that there is an adjacent PM or UAM means, another person may be able to drive it, and in that case, the adjacent PM or UAM means can be re-reserved.

Hereafter, configurations other than the MOD engine 100 will be described in detail.

The mobility service unit 2000 may provide an interface for input/output to or from the user terminal 700, receive the user's request, and send a dispatch request to the optimal dispatch unit 150.

In this case, the mobility service unit 2000 may include a boarding request input unit 2005, a multiple transportation means linkage selection interface 2030, and a dispatch interface 2040. The boarding request input unit 2005 may include a departure point and destination point input interface 2010 and a departure time or arrival time input interface 2020.

The departure point and destination point input interface 2010 may include, for example, a map input means (e.g., 1450) as shown in FIG. 14 or an input interface that may search for and select a POI through text input.

The departure time or arrival time input interface 2020 may include, for example, a departure time input means 1440 or an arrival time input means 1470 as shown in FIG. 14. In this case, the expected arrival time when departing at the departure time inputted in the departure time input means 1440 and arriving at the destination point through a MOD vehicle and linkage transportation means can be calculated and inputted in the arrival time input means 1470. In case that the user inputs the arrival time in the arrival time input means 1470, the time at which the arrival time can be observed with a higher probability than the reference probability is calculated inversely, and the departure time at which the arrival time can be guaranteed is inversely presented through the departure time input means 1440.

Even after inputting the arrival time, a time other than the recommended time can be manually inputted. However, it can be controlled so that manual input is not possible before a time at which the arrival time can be observed.

The multiple transportation means linkage selection interface 2030 provides a means for the user terminal 700 to input a preferred transportation means among linkage transportation means when operating outside the operation area of the MOD system 1000. In other words, the user can input the linkage transportation means at the boarding point or alighting point of the MOD bus through the multiple transportation means linkage selection interface 2030. For example, referring to FIG. 14, the multiple transportation means linkage selection interface 2030 may provide transportation means selection menu 1420 and 1430. In this case, the transportation means selection menu may provide a linkage transportation means available at the corresponding location. In this case, in the case of PM or UAM, the real-time location of the corresponding transportation means can be monitored and reflected in the menu. In this case, a reservation can be made if the number of PM or UAM at the transfer location to use the corresponding transportation means is below a certain number, and when making the reservation, operation of the reserved transportation means by others may be restricted. However, in this case, additional reservation fees may be incurred.

The demand forecasting unit 3000 can perform boarding demand analysis and real-time demand forecasting. The boarding demand analysis and real-time demand forecasting can be done based on boarding history, information on floating population within a certain distance from the corresponding boarding and alighting points, weather, demand-triggering event information, day of the week, public transportation obstacle information, and real-time reservation situation. By obtaining the probability of demand occurrence for the above-described history information, for example, Bayesian probability through the collection of operation information, the probability of demand occurrence for each boarding and alighting point can be obtained. The demand estimated by the demand estimation unit 500 can be used for MOD vehicle rearrangement, dispatch reservation, route setting, etc.

The data analysis unit 4000 can perform data analysis based on boarding history data and operation data to thereby provide static route optimization and dynamic dispatch simulation. Also, personalized travel suggestion can be made. Based on the user's boarding and alighting history and the operation information of the boarding vehicle, user movement pattern analysis and preferred transportation means analysis can be performed, and based on this, optimal transportation means suggestion and optimal moving route suggestion information can be created.

The operation management unit 5000 is a server that manages the overall service operation, and can perform vehicle control (rearrangement, dispatch, real-time vehicle location monitoring, etc.), customer management (management of various customer information including customer's boarding and alighting history, reservation history, boarding and alighting location, boarding and alighting time, etc.) and autonomous driving control.

The autonomous driving interworking gateway 1050 interworks with the autonomous shuttle (200), autonomous delivery vehicle (400), and MOD engine (100), and can serve to transmit the vehicle's route and control signals and transceive passenger boarding and alighting information, real-time location and speed of vehicle, etc. The mobility vehicle interworking interface 1070 is interworking with MOD passenger transportation 300, MOD logistics delivery vehicle 500, MOD transportation weak person support vehicle 600 and MOD engine, and can serve to transmit the vehicle's route and control signals and transceive passenger boarding and alighting information, real-time location and speed of vehicle, etc.

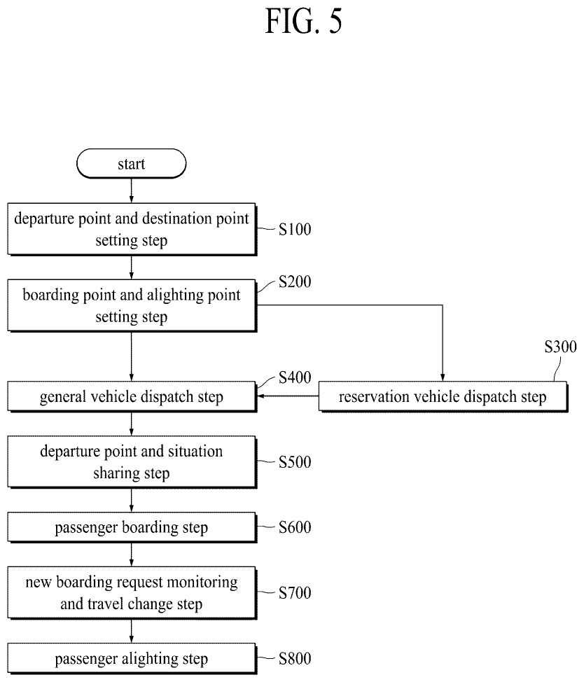

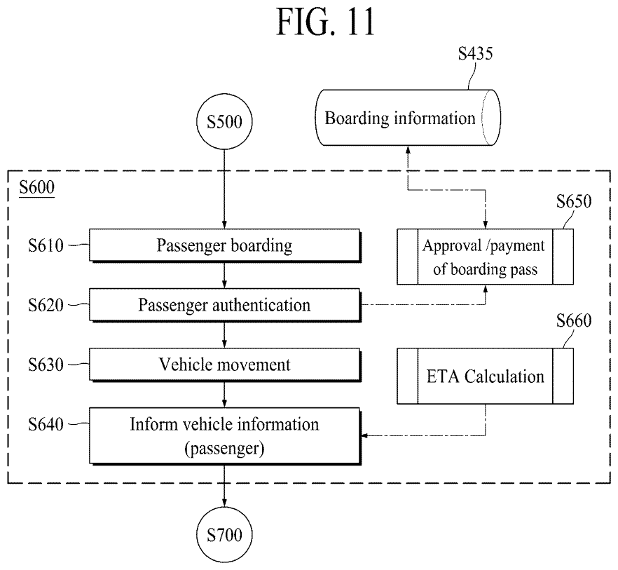

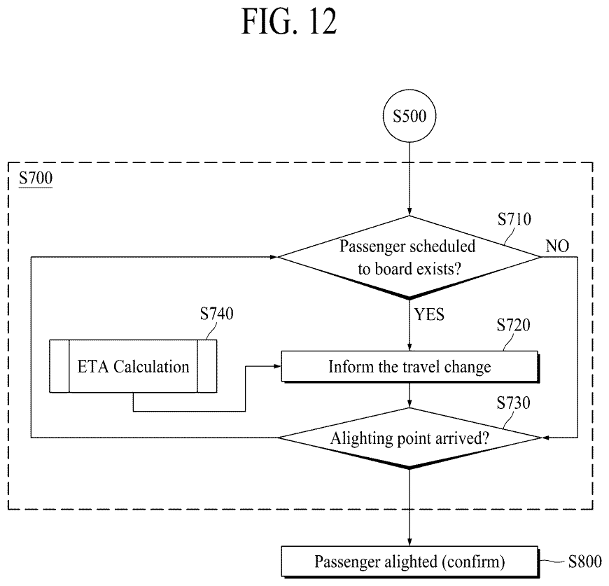

Hereinafter, with reference to FIGS. 5 to 12, the overall dispatch process of the MOD system 100 according to an embodiment of the present invention will be described in detail.

First, referring to FIG. 5, the overall dispatch process of the MOD system 100 according to an embodiment of the present invention may include a departure point and destination point setting step (S100), a boarding point and alighting point setting step (S200), and a reservation dispatch step (S300), general dispatch step (S400), vehicle movement to the departure point and situation sharing step (S500), passenger boarding step (S600), new boarding request monitoring and travel change step (S700), and passenger alighting step (S800).

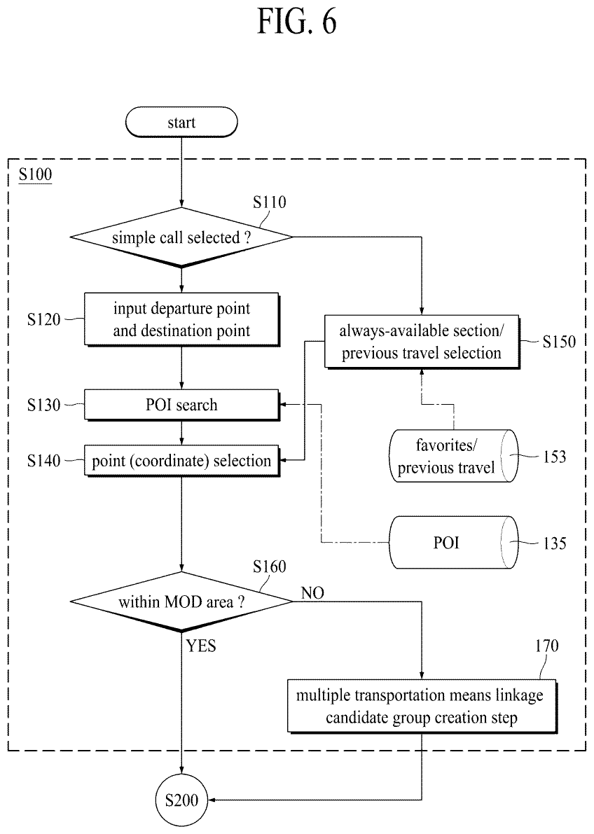

First, referring to FIG. 6, the departure point and destination point setting step (S100) may include the simple call selection step (S110), departure point and destination point input step (S120), POI search step (S130), and point selection step (S140), an area determination step (S160), and a multiple transportation means linkage candidate group creation step (S170).

In the simple call selection step (S110), the departure point/destination point input interface 2010 may receive, from the user terminal 700, a selection signal regarding whether to receive the departure point/destination point input as a simple call.

If the simple call is selected, the departure point/destination point input interface 2010 is an always-available section and can receive the departure point/destination point from the user terminal 700 by selecting a section set by the user or previous travel history. (S150)

Meanwhile, if it is not a simple call, a new departure point/destination point can be inputted from the user terminal 700 through selection of text or location on the map. (S120)

If the departure point/destination point is inputted from the user terminal 700, the departure point/destination point input interface 2010 selects, through POI search (S130), the coordinates of the departure point and destination point. (S140) If there are multiple coordinates corresponding to the departure point or destination point keyword, one coordinate among them is selected. When selecting between a section set by the user as an always-used section or a previous journey history (S150), the always-used or previous history departure point and destination point are selected as coordinates.

Meanwhile, if the coordinates of the departure point and destination point are selected, it is determined whether the coordinates of the departure point and destination point are within the area of the MOD system 1000. The multiple transportation means area determination unit 191 can determine whether the departure point or destination point is within the area of the MOD system 1000. The area may mean the regional scope where the MOD system is operated.

If the departure point or destination point is outside the area of the MOD system 1000, the process proceeds to the multiple transportation means linkage candidate group creation step (S170). If it is within the area, the boarding and alighting point setting step (S200) is performed.

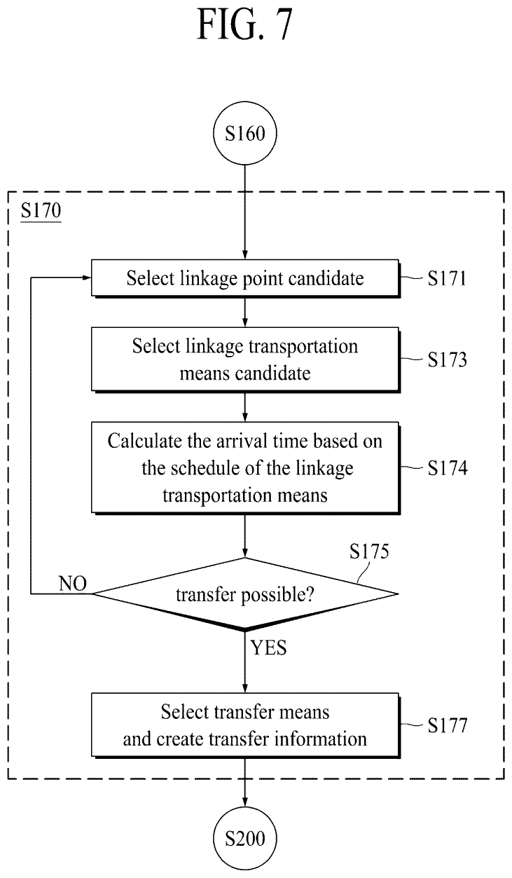

Hereinafter, the multiple transportation means linkage candidate group creation step (S170) will be described in more detail with reference to FIG. 7.

the multiple transportation means linkage candidate group creation step (S170) may include the linkage point candidate selection step (S171), the linkage transportation means candidate selection step (S173), the transfer possibility determination step (S175), and the linkage means selection and transfer information creation step (S177).

In the linkage point candidate selection step (S171), the optimal transfer point creation unit 193 determines that among the boarding and alighting points within the first reference distance from the boundary of the area, the boarding and alighting point of the linkage transportation means is within the second reference distance. You can select a point where you can board and alight as a post-linkage point. Here, linkage transportation means may include metropolitan transportation such as railways and airplanes, public transportation such as buses and subways, and PM and UAM. For PM, the real-time location of available PMs can be viewed as a boarding and alighting point, for railways, a railway station, for a bus, a bus stop, for a subway, a subway station, for an airplane, an airport, and for UAM, a take-off and landing pad can be seen as a possible boarding and alighting point.

Once a linkage point candidate is selected, the optimal transfer means calculation unit 195 can select a linkage transportation means candidate. (S173) In this case, the linkage transportation means candidate may include transportation means that can stopover and stop in a place within the destination point and the third reference distance among linkable transportation means that can be linked in the linkage point candidates. In this case, the third reference distance may be different for metropolitan transportation means, public transportation means, PM, and UAM because the coverage of each transportation means may be different. For example, the third reference distance becomes larger in the order of PM, public transportation means, UAM, and metropolitan transportation means.

If a candidate for the linkage transportation means is selected, the optimal arrival time calculation unit 197 based on the transfer means schedule can calculate the arrival time based on the schedule of the linkage transportation means. (S174) Then, the travel calculation unit 160 determines whether transfer is possible. (S175)

Whether or not transfer is possible can be determined based on the walking distance from the user's MOD vehicle boarding or alighting point to the linkage transportation boarding or alighting point. The walking distance may vary depend on the user's gender, age, disability, temperature, weather, walking distance set by the user, and the altitude difference from the MOD vehicle boarding or alighting point to the linkage transportation means boarding or alighting point.

If there are multiple linkage transportation means determined to be transferable, the travel calculation unit 160 can determine the optimal linkage transportation means and recommend the linkage movement schedule based on whether punctuality can be guaranteed, the transfer convenience to the linkage transportation means or the amount of carbon emission reduction. In this case, the very first thing to be considered is transfer convenience, which may be considered based on optimal dispatch and route. If the destination point is outside the area including the departure point, it may be considered to minimize the arrival time of the vehicle before transfer at the transfer point and the arrival time of the vehicle after transfer and to minimize the distance between locations before and after transfer.

Therefore, the MOD system of the present invention can provide seamless passenger convenience by providing transfer convenience. The MOD system of the present invention can provide passengers with the experience of traveling far distances with minimal transfers at the cost of using public transportation by increasing transfer convenience even when the passenger's destination is outside the business area of the MOD system.

MOD vehicles are used as a way to implement this, and the MOD system of the present invention can provide an experience similar to what passengers travel from the departure point to the destination point at once without transfers using a private vehicle or taxi at a low fare.

In this case, it is the MOD vehicle that provides a seamless experience, and the existing waiting time is eliminated through the MOD vehicle to eliminate the inconvenience of having to endure inconvenient travel or wait for an excessively long period of time to transfer to existing public transportation. The present invention has been designed to dispatch MOD vehicles between the departure point and the destination point to thereby minimize walking for transfers.

Meanwhile, the travel calculation unit 160 may determine the optimal linkage transportation means based on the actual walking distance and minimum carbon emission (the amount of maximum carbon reduction). For example, if the difference in walking distance between two different transferable transportation means is within a certain distance, the carbon emission reduction saving can be calculated and the linkage means with greater saving can be selected.

The travel calculation unit 160 may calculate the emission coefficient as shown in Equation 1 below, and then calculate the carbon emission based on the emission coefficient.

$$Emission coefficient ( y ) = A ⋆ {V}^{B} ( where A and B are constants according to transportation means , and V is speed ) \qquad ( Equation l )$$

For example, if the transfer means used is a van that is a MOD vehicle bus, the emission coefficient can be calculated as in Equation 3 below.

$$( Equation 2 )$$

$$Emission coefficient ( y ) = 1103.7 ⋆ {V}^{- 0.413} ( where V is speed )$$

Alternatively, in the case of small passenger cars, the emission coefficient can be calculated as shown in Equation 3.

$$( Equation 3 )$$

$$Emission coefficient ( y ) = 937.56 ⋆ {V}^{- 0.4506} ( where V is speed )$$

After the emission coefficient is calculated as in Equation 1 to Equation 3, the amount of carbon emissions emitted by the corresponding transfer means can be calculated based on the vehicle's expected travel distance. In this case, the unit of the emission factor may be, for example, the weight of carbon emissions per unit distance (g/km).

At this time, after the carbon emissions are calculated, the amount of carbon emission reduction is on the basis of one person moving a certain distance by car, and can be determined by the amount of emissions reduction when using a MOD vehicle or public transportation means compared to that basis. For example, it is possible to obtain the difference between the carbon emissions of the corresponding distance of a passenger car and the carbon emissions of the corresponding distance of each transfer means, and to calculate the difference as the amount of carbon emission reduction. In this case, the amount of total carbon emissions of MOD vehicles, buses, subways, etc. can be obtained by dividing the total carbon emissions based on the transfer time of the transfer section by the average number of passengers in the transfer section.

Again, referring to FIG. 5, in the boarding and alighting point setting step (S200), the optimal boarding and alighting point calculation unit 110 sets the boarding and alighting point of the MOD. In this specification, the boarding point means the location where the user 700 boards the MOD vehicle 200, 300, 600, and the alighting point means the location where the user 700 gets off from the MOD vehicle 200, 300, 600. The boarding/alighting point encompass the boarding points and alighting points.

More specifically, the optimal boarding and alighting point calculation unit 110 may first match the coordinates of the departure points and destination points with adjacent roads among locations selected as possible boarding and alighting points on the road through analysis of boarding and alighting points. (S210)

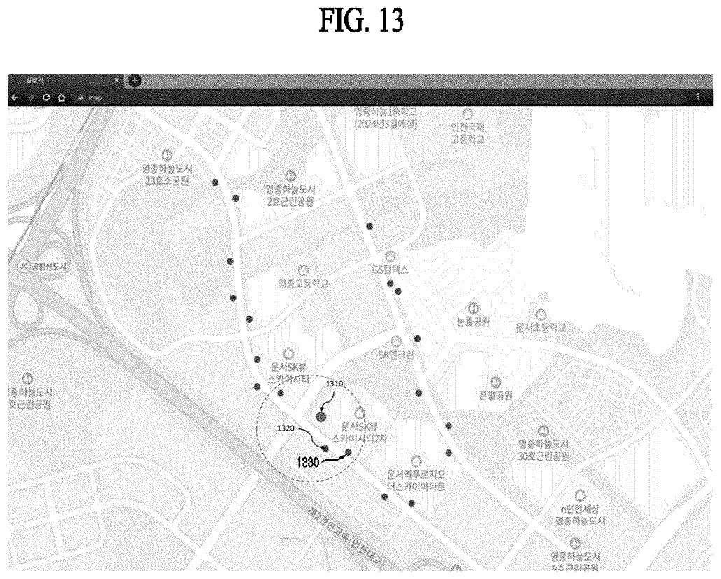

After matching adjacent roads, the boarding and alighting point analysis unit 113 may create boarding and alighting possible points based on whether boarding and alighting is possible, for example, information on coordinates of dangerous boarding and alighting points at points on the road, actual boarding and alighting history, whether an area where stopping is possible by vehicle type or vehicle size, whether walking movement, movement in a wheelchair, and select a plurality of boarding and alighting points on roads adjacent to the coordinates of the departure point and destination among the plurality of created boarding and alighting points. (S220) Also, the coordinate information of the dangerous boarding and alighting point can be updated in real time depending on whether there is a construction zone, whether there is an accident, or traffic conditions. For example, referring to FIG. 13, points where parking is possible are predetermined and stored in the service database 145. (The red dots in FIG. 13 represent candidates for boarding and alighting points.)

And, the boarding and alighting point calculation unit 115 may receive the boarding and alighting point history of the database 117 (S235), check the user's previous boarding and alighting point history (S230), and perform a search for adjacent boarding and alighting passengers (users who requested new boarding) in real time. (S240).

And, the boarding and alighting point calculation unit 115 may receive the walking network information stored in the service database 145 (S255) and create a walking route from the departure point to the candidate boarding and alighting point or from the destination point to the candidate boarding and alighting point (S250), and check whether the walking movement time is within the reference time. At this time, the walking movement time may be determined differently depending on the weather, temperature, humidity, and the user's age, gender, or disability. This information can also be received through an external server.

Meanwhile, the boarding and alighting point calculation unit 115 can evaluate the movement direction of the MOD vehicle and check whether the movement direction on the road matches the boarding and alighting point. For example, if the direction of movement of the MOD vehicle is A->B direction (up or down), it can be confirmed that the boarding and alighting points on the lane that matches the A->B direction among the lanes of the road are matched. For example, if the movement direction from the departure point 1310 is towards Unseo Station Prugiothesky Apartment, the boarding and alighting point candidate 1320 among the boarding and alighting point candidates can be selected as the boarding point.

Thereafter, the boarding and alighting point calculating unit 115 may select the boarding and alighting points among the candidate boarding and alighting points and create boarding and alighting point information (S270).

The boarding and alighting point information may include the location of the boarding and alighting point, transfer location, and walking route from the departure point and destination point. For example, the boarding and alighting point calculation unit 115 may select the boarding and alighting points among the candidate boarding and alighting points based on whether it is an area where boarding and alighting is possible, the user's boarding and alighting history, the walking route, whether there are adjacent boarding and alighting passengers (walking time or distance is below the reference), and the direction of vehicle movement on the road.

Meanwhile, the departure time/arrival time input interface (2020) may proceed with input of the departure time or arrival time, and determine whether the arrival time has been selected (S280) and inputted (S285). When the arrival time is inputted, the probability of observation of the arrival time is calculated, and availability of a reservation can be determined based on whether the arrival time can be observed above a certain probability.

The times mentioned in this specification include departure time, arrival time, reservation reference time, and estimated arrival time. Departure time and arrival time may mean the time inputted by the user as departing and arriving time or departed time and arrived time. The reservation reference time may mean a certain time to be recognized as a reservation. If the departure or arrival time is inputted at the time which is very close to the departure time, it is difficult to make a reservation, and therefore, upon setting of the reservation reference time, only if the departure time is inputted before the reservation reference time or the departure time in which the probability of observing the arrival time from the arrival time has been calculated beyond the a certain possibility is before the reservation reference time, the reservation can be determined to be possible.

If the arrival time is inputted in the arrival time input step (S285), it is possible to determine whether the arrival time can be reserved. In other words, it can be determined whether the probability of observing the arrival time is faster than the departure time above a certain level by the reservation reference time, and depending on the decision, the reservation process (S300) or real-time dispatch (S400) is progressed.

Meanwhile, if it is difficult to observe the arrival time even if real-time dynamic dispatch (S400) is progressed, a message indicating that it is difficult to observe the arrival time is sent to the user terminal 700. Even in the case of inputting of the departure time, if the reservation is not possible due to inputting of the departure time after the reservation reference time, a message notifying that reservation is not possible and real-time dispatch can be sent to the user terminal 700.

If the departure time or arrival time is inputted and a reservation is possible based on the inputted departure time or arrival time, the reservation dispatch process (S300) will proceed. If the departure time or arrival time is not inputted, the reservation dispatch process (S300) will proceed. The real-time dynamic dispatch process (S400) begins immediately.

If a reservation-available departure time or arrival time is inputted, the reservation dispatch calculation unit 157 first checks whether there exists other reserved passenger departing from an adjacent area (area within a certain distance) during a predetermined period. (S310) If there exists the other reserved passenger, the reservation dispatch calculation unit 157 detects the travel similarity with other reserved passenger. (S320) The travel similarity calculates the consistency of links and/or nodes between the boarding point and the alighting point. The degree of correspondence of links and/or nodes may be calculated based on the number of overlapping links and/or nodes. In this case, if the match between links or nodes is high (higher than the reference match), the match can be further increased by changing the boarding point or drop-off point of other reserved passengers or users who inputted the departure time. In this case, depending on the user, if the user has a disability or is accompanied by an infant, a higher weight can be given to the match, providing a higher probability of reservation dispatch to the disabled customer or customer accompanying an infant (i.e., reservation dispatch probability). probability can be increased).

Meanwhile, the predetermined period of time that is the reference for the reservation boarding request can be changed by a machine learning. For example, the predetermined period of time can be determined by calculating and updating the probability to input other reservation boarding request.

At this time, it is checked whether other reserved passenger with similar travel (if the consistency of node or link is higher than the reference consistency) are more than the reference number of passengers (S350), and if the number of passengers is more than the reference number of passengers, the reservation dispatch proceeds. (S340) In this case, if the reservation dispatch has proceeded, the fare can be discounted depending on the difference between the departure times.

Alternatively, if there are no other reserved passengers, it is checked whether the predetermined time for reservation has elapsed (S350), and if the predetermined time for reservation has elapsed, reservation dispatch (S340) can be performed even if the number of passengers with similar travel is less than a certain number. Even after reservation dispatch is performed, a real-time dynamic dispatch procedure (S400) can be performed.

Meanwhile, when there is no input of departure time along with setting the boarding and alighting points, or when reservation dispatch is completed, or before the vehicle arrives, dynamic dispatch (S400) may be continuously made.

Real-time dynamic dispatch (S400) can be performed in the optimal dispatch unit (150).

First, the dispatch calculation unit 153 can receive vehicle information. (S415) In this case, the dispatch calculation unit 153 may receive vehicle information including the ID and real-time location information of each vehicle.

And, the dispatch calculation unit 153 can generate a dispatch candidate group by searching for dispatch-available vehicles. (S410) In this case, the dispatch candidate group can be determined based on whether or not the departure point and destination point pass through the existing boarding forecast point and alighting forecast point of the relevant MOD vehicle or adjacent areas, whether or not the detour time of the existing dispatched or boarded passengers when boarding the dispatch request user is below the reference, and the ETA to the boarding point of the dispatch request user.

Meanwhile, when dispatch candidate vehicles are searched, it is possible to check whether there exists an arrival time that must guarantee punctuality. In other words, it is confirmed whether the arrival time has been inputted. (S420)

When it is confirmed whether the arrival time has been inputted, the dispatch calculation unit 153 can receive the operation information history (S425) and search for a vehicle that can observe the arrival time from among the MOD vehicles corresponding to the dispatch candidate group. Specifically, if the user boards the vehicle at the time when arriving at the corresponding boarding point of the MOD vehicle corresponding to the dispatch candidate group, it is checked whether the probability to observe the arrival time is above a certain level to determine whether the vehicle is likely to observe the arrival time (S430). In this case, the punctuality guarantee unit 155 can calculate the possibility to observe the arrival time of the dispatch candidate group and transmit the calculation result to the dispatch calculation unit 153. (S460)

And, it is checked whether there is existing passenger in the vehicle (S440), and it is determined whether the arrival time requested by the existing passenger is observed (S450). In this case, the punctuality guarantee unit 155 can calculate the possibility of observing the arrival time requested by the existing passenger based on the route changed due to the boarding of the dispatch request user and transmit the calculation result to the dispatch calculation unit 153 (S460).

If there is a high probability that the arrival time requested by the existing passenger will not be observed when boarding of the dispatch request user, the process returns to the step S430 of searching for a vehicle that can observe the arrival time among the dispatch candidates. When there is no vehicle that can observe the arrival time among the dispatch candidates, a message indicating that it is difficult to observe to the arrival time may be sent to the user terminal 700 again.

Once it is confirmed whether the arrival times requested by dispatch request user and the existing passengers are likely to be observed, the real-time dynamic dispatch unit 155 can dispatch the dispatch candidate vehicle with the lowest ETA and remaining seats. Additionally, the dispatch information generation unit 159 may generate dispatch information for the dispatched vehicle and transmit the dispatch information to the user terminal 700 and the MOD vehicles 200, 300, and 600. (S480)

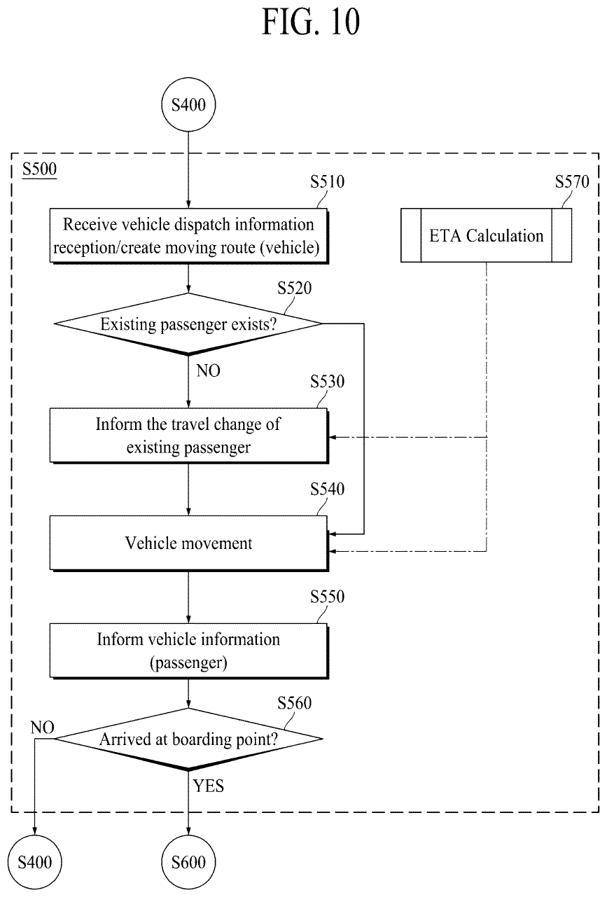

Referring to FIG. 10, after dispatch is completed, the dispatched vehicle can move to the boarding point. After receiving the dispatch message, the mobility service unit 2000 can generate a movement route and deliver dispatch information to the vehicle. At this time, if there exists a customer who boarded the vehicle first (S520), the ETA is calculated (S570), the previously boarded customer is informed of the travel change according to the changed travel along with the ETA (S530), and then the vehicle moves. (S540) Even while the vehicle is moving, the ETA for the relevant vehicle's boarding point can be continuously calculated and provided. Also, the vehicle information is guided to the user terminal 700. (S550)

Thereafter, the mobility service unit 2000 checks whether or not the arrival of the vehicle and proceeds with the user boarding step (S600). However, before the vehicle arrives at the boarding point, the dynamic dispatch step (S400) can be performed again. For example, if the ETA changes beyond the reference due to a change in traffic conditions before the vehicle arrives at the boarding point, the dynamic dispatch step (S400) can be performed again.

When the user having a user terminal 700 boards (S610), passenger authentication (S620) is performed, and at this time, approval and payment of the boarding pass are performed. (S650) However, the payment step may be carried out during alighting. Passenger authentication 620 can transmit the ID of the user terminal 700 to the MOD vehicle 200 through a communication linkage means, for example, Bluetooth, NFC, Zigbee, UWB, etc., which are close proximity communication means. Alternatively, passenger authentication 620 may also be performed using a biometric recognition method such as facial recognition by a camera and the like or a method of recognizing sitting in a specific seat and the like. For example, when facial recognition is performed through a camera installed at the boarding gate of a MOD vehicle or a user sits in a specific reserved seat, passenger authentication (S620) can be also performed in a manner of authentication by a specific seat recognition through a camera and the like.

The vehicle can calculate the fare for the received user terminal 700 ID through the dynamic fare calculation unit 130, and proceed with payment and authentication through the mobility service unit 2000. (S650) After approval/payment of the boarding pass is completed, boarding information and remaining seat information for the relevant vehicle are updated. (S435)

After passenger authentication, the vehicle departs for the alighting point (S630), and information about departure is informed of the passenger. (S640)

Meanwhile, while moving to the alighting point (S700), it is continuously checked whether there exists new boarding customer (S710), and if there exists the new boarding customer exists, the ETA is calculated (S740) and updated, a travel change is notified along with the new ETA. (S720) At this time, when arriving at the alighting point, it is checked whether the passenger has alighted. (S800) In this case, a passenger's alighting can be confirmed through close communication means such as Bluetooth, NFC, Zigbee, UWB, etc. Alternatively, the confirmation of the passenger's alighting may be accomplished through a biometric recognition method such as facial recognition by a camera and the like, tracking movement from boarding to alighting, automatic payment upon arrival at a set alighting point, or recognition of leaving the seat and alighting through a camera.

Therefore, according to the present invention, Therefore, according to the present invention, a MOD system that is linked to public transportation when leaving a designated area can be provided. In particular, a MOD system may be provided that allows users to conveniently determine a connecting means by providing a user interface for determining a connecting means of public transportation.

Also, according to the present invention, a MOD system may be provided that provides a user interface capable of determining linked public transportation means so that the user can conveniently determine a linkage means.

Also, according to the present invention, a MOD system that can guarantee punctuality while being linkage to public transportation means, etc. can be provided.

Also, the present invention is to provide a means capable of operating a MOD vehicle in an environment-friendly manner by providing a transfer means for the MOD vehicle according to the amount of carbon emission reduction.

Also, according to the present invention, a reservation means for the MOD system can be provided that can directly reflect the demand for MOD vehicles by allowing users with similar departure/destination points to board one bus if possible, and that enables the operation of MOD vehicles with maximized cost efficiency from the operator's perspective.

Although the embodiments of the present invention have been described in more detail with reference to the attached drawings, the present invention is not necessarily limited to these embodiments, and various modifications may be made within the scope departing from the technical spirit of the present invention. Accordingly, the embodiments disclosed in the present invention are not intended to limit the technical idea of the present invention, but are for illustrative purposes, and the scope of the technical idea of the present invention is not limited by these embodiments. Therefore, the embodiments described above should be understood in all respects as illustrative and not limited. The scope of protection of the present invention should be interpreted by the claims below, and all technical ideas falling in the equivalent scope thereto should be interpreted as being included in the scope of rights of the present invention.

What is claimed is:

1. A mobility on demand (MOD) system comprising:
a mobility service unit including a boarding request input unit for receiving, from a user, a boarding request including information on a departure point and a destination point from a user; and
an optimal dispatch unit for calculating an optimal dispatch and route in response to receiving the user's boarding request, and dispatching a MOD bus; and
a travel calculation unit for planning a route linked with transfer means including public transportation, metropolitan transportation, or other MOD means other than the MOD vehicle in case that the departure point and the destination point belong to different areas.

2. The MOD system according to claim 1,
wherein the MOD system further includes a multiple transportation linkage unit, and the multiple transportation linkage unit includes an optimal stopover point creation unit for adding a transfer linkage stopover point for transfer to the linkage transportation means at the departure point and destination point.

3. The MOD system according to claim 1,
wherein the MOD system further includes a multiple transportation means linkage unit, wherein the multiple transportation means linkage unit may include an optimal arrival time calculation unit based on a transfer means schedule for calculating the detour or stopover arrival time for stopover point of the MOD bus based on the arrival time and waiting time of the linked transportation means and the arrival time at the destination during detouring or stopover of the transfer linkage stopover point.

4. The MOD system according to claim 1,
wherein the MOD vehicle operating system further includes a multiple transportation means linkage unit, the multiple transportation means linkage unit dispatches buses according to the arrival time of the transfer stopover of the MOD bus based on the departure time of the linked transportation means or according to the departure time of the MOD bus based on the arrival time of the linked transportation means.

5. The MOD system according to claim 1,
wherein the MOD system further includes a multiple transportation means linkage unit, and the multiple transportation means linkage unit includes an optimal transfer means calculation unit for recommending a linked transportation means according to the user's preferred travel condition.

6. The MOD system according to claim 5,
wherein the user's preferred travel condition includes at least one of travel time, transfer convenience, travel convenience, in-vehicle congestion, and the amount of carbon emission reduction.

7. The MOD system according to claim 1,
wherein the travel calculation unit recommends a linked travel schedule based on whether to guarantee punctuality, the convenience of transferring with linked transportation means, or the amount of carbon emission reduction.

8. The MOD system according to claim 7,
wherein the convenience of transfer with the above transfer linkage means may be determined depending on the walking distance or time.

9. The MOD system according to claim 7,
wherein whether to guarantee the punctuality may be whether the probability calculated based on the probability density function for the user's boarding probability based on the ETA to the user's MOD vehicle alighting point, the departure time of linked transportation means that can observe the arrival time, or the walking travel time from the user's MOD vehicle alighting point to the other transportation means boarding point is greater than the reference probability.

10. The MOD system according to claim 7,
wherein the amount of carbon emission reduction is calculated based on the difference between the amount of carbon emission of transfer means compared to the amount of the carbon emission of passenger vehicles.

11. The MOD system according to claim 10,
wherein the amount of carbon emission is calculated based on the emission coefficient calculated by Equation 1 below: (Equation 1) Emission coefficient (y)=A*V^(B) (where A and B are constants according to transportation means, and V is speed).

12. The MOD system according to claim 10,
wherein if the transfer means is a MOD vehicle, bus, or subway, the amount of carbon emission of the transfer means can may calculated by dividing the total amount of carbon emission based on the transit time of the transfer section by the average number of passengers in the transfer section.

13. The MOD system according to claim 1,
wherein the mobility service unit further includes a multiple transportation means selection interface, and the travel calculation unit can recommend at least some of public transportation, metropolitan transportation, or other MOD means through the multiple transportation means selection interface.

14. The MOD system according to claim 13,
wherein the mobility service unit includes a multiple transportation means selection interface, and the travel calculation unit recommends at least some of public transportation, metropolitan transportation, or other MOD means as a linked travel schedule through the multiple transportation means selection interface.

15. The MOD system according to claim 14,
wherein the travel calculation unit recommends the linkage travel schedule in order based on at least part of whether to guarantee punctuality, the convenience of transfer or the amount of carbon emission reduction.

16. The MOD system according to claim 15.
wherein the convenience of transfer may include walking travel distance or time. wheelchair accessibility or walkability.
